(19) United States
(12) Patent Application Publication
(10) Pub. No.: US 2020/0298795 A1
(43) Pub. Date: Sep. 24, 2020

(54) SEAT BELT ASSIST DEVICE AND METHODS OF USE

(71) Applicant: Danielle Sokolowski, Sayreville, NJ (US)

(72) Inventor: Danielle Sokolowski, Sayreville, NJ (US)

(21) Appl. No.: 16/822,180

(22) Filed: Mar. 18, 2020

Related U.S. Application Data
(60) Provisional application No. 62/819,713, filed on Mar. 18, 2019.

(51) Int. Cl. B60R 22/48; B60R 22/02; B60R 22/12; B60R 11/02

(52) U.S. Cl. CPC B60R 22/48; B60R 22/02; B60R 2011/0012; B60R 11/0217; B60R 2022/4816; B60R 22/12

(57) ABSTRACT

A seat belt assist device for use with a seat belt having a webbing, a tongue and a buckle, the assist device including an upper sleeve for wrapping around a portion of the webbing adjacent the tongue, the upper sleeve having a first distinctive marker, a lower sleeve for wrapping around a portion of the webbing adjacent the buckle, the lower sleeve having a second distinctive marker, the second distinctive marker being the same as the first distinctive marker, a first sensor component disposed on the upper sleeve adjacent the tongue, and a second sensor component disposed on the lower sleeve adjacent the buckle, the first sensor and the second sensor being capable of signaling their position relative to one another.

### CROSS-REFERENCE TO RELATED APPLICATIONS

This application claims priority to U.S. Provisional Application Ser. No. 62/819,713, filed Mar. 18, 2019, the contents of which are hereby incorporated by reference as if fully set forth herein.

### FIELD OF THE DISCLOSURE

The present disclosure relates to seat belts used in the transportation industry. More particularly the present disclosure relates to devices and methods for assisting and ensuring that individuals wear their seat belts properly.

### BACKGROUND OF THE DISCLOSURE

Seatbelts reduce the risk of injury in many types of crashes by helping to properly position occupants, while the seat belt is designed to stretch at a controlled rate to absorb impact energy and reduce the severity of the occupant's deceleration. Studies show that seatbelts reduce the overall risk for serious injuries in crashes by about 60%, and seatbelts reduce the risk for fatalities by approximately 45%. This is of particular importance because motor vehicle crashes are a leading cause of death among those aged 1-54 in the U.S., and the U.S. National Highway Traffic Safety Administration (NHTSA) estimates that in the United States alone, seat belts save more than 12,500 lives each year, and prevent over 300,000 serious injuries.

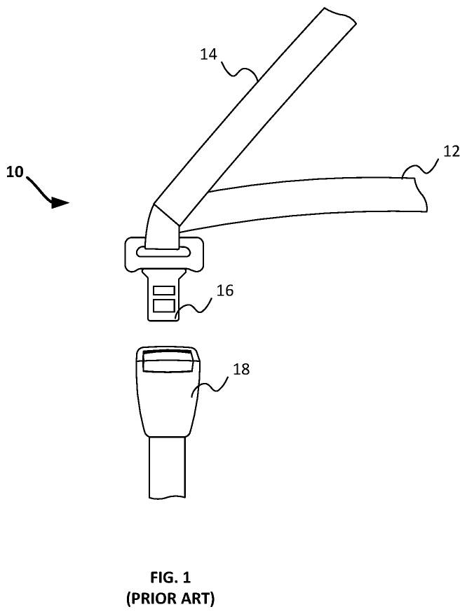

As shown in FIG. 1, seat belts 10 used in vehicles generally include a lap belt 12 that goes over the waist of an individual and a diagonal sash 14 that extends over the occupant's chest and shoulder. The lap belt 12 and sash 14 are sometimes called a “webbing” of a seat belt. A retractor (not shown) may be coupled to the webbing to wind it and the webbing may have sensor(s) that lock the webbing when the vehicle's speed changes suddenly, or when the webbing is pulled suddenly. The webbing is typically coupled to a metallic tongue 16. This metallic tongue 16 is, in turn, coupleable to a buckle 18, which is typically placed between the lower cushion and the seatback in a vehicle.

Children may have a difficult time coupling the tongue 16 to the buckle 18. Additionally, vehicles typically have multiple buckles and seatbelts in the back seat (e.g., three sets of buckles/seatbelts) and children may be confused as to which of the systems is associated with their seat. This may lead to confusion and perhaps possibly dangerous positioning of the seat belts if a tongue is coupled to an incorrect buckle. Thus, direct supervision or assistance of an adult is typically required. Moreover, it is difficult for parents of young children to ascertain proper buckling without visual inspection.

### SUMMARY OF THE DISCLOSURE

In some embodiments, a seat belt assist device is used with a seat belt having a webbing, a tongue and a buckle. The assist device includes an upper sleeve for wrapping around a portion of the webbing adjacent the tongue, the upper sleeve having a first distinctive marker, a lower sleeve for wrapping around a portion of the webbing adjacent the buckle, the lower sleeve having a second distinctive marker, the second distinctive marker being the same as the first distinctive marker, a first sensor component disposed on the upper sleeve adjacent the tongue, and a second sensor component disposed on the lower sleeve adjacent the buckle, the first sensor and the second sensor being capable of signaling their position relative to one another.

### BRIEF DESCRIPTION OF THE DISCLOSURE

Various embodiments of the presently disclosed devices and systems are disclosed herein with reference to the drawings, wherein:

FIG. 1 is a schematic illustration of a prior art seat belt system;

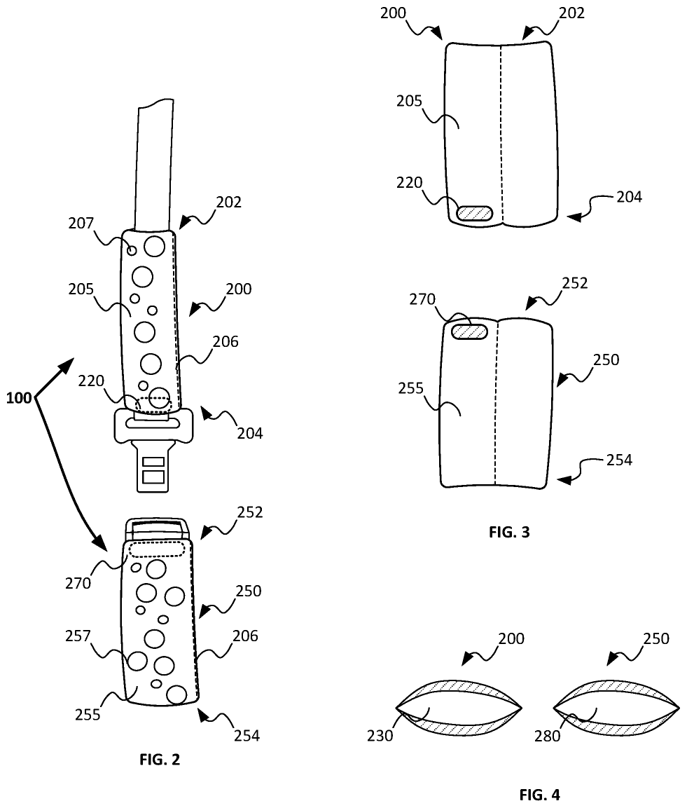

FIG. 2 is a schematic front view of a system having the assist device according to one embodiment of the disclosure;

FIG. 3 is a schematic front view of the sleeves prior to assembly;

FIG. 4 is a schematic end view of the sleeves of FIG. 3 when assembled; and

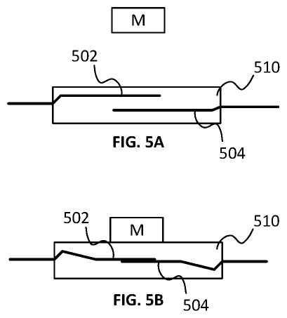

FIGS. 5A-B are diagrams showing one example of a reed switch.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to seat belts, conventional methods suffer from some shortcomings as discussed above.

There therefore is a need for further improvements to the devices and methods used to couple and decouple seat belts, and particularly to assist children with doing so. Among other advantages, the present disclosure may address one or more of these needs.

FIG. 2 illustrates the use of seat belt assist device 100 to address some of these problems. Assistance device 100 generally includes an upper sleeve 200 configured to fit around a portion of the webbing near the tongue and a lower sleeve 250 configured to fit at least partially around the buckle or a portion of webbing connected to the buckle. Upper sleeve 200 may extend between a first end 202 and a second end 204 and may include a body 205 formed of fabric, cloth, plastic, rubber, or other suitable material. In at least some examples, the body 205 may include a stretchable material, such as spandex. In some examples, body 205 may be formed as a generally flat rectangular sheet that is rolled to form a generally round sleeve defining a lumen 230, the lumen 230 being large enough to receive a portion of a webbing (FIGS. 2 and 3). A seam 206 or stitching may couple two ends of the rectangular sheet together to form the round configuration. Alternatively, instead of a seam, two ends of the rectangular sheet may be coupled via a hook-and-loop system, such as VELCRO® brand of fastening systems so that a round configuration is easily formed. As used herein, the term “round” does not necessarily imply a cylindrical configuration, but rather any shape that has a closed or substantially closed perimeter when seen from an end view. Body 205 may have a first distinctive marker 207. As shown, distinctive marker 207 may include a series of colored circles. Alternatively, distinctive marker 207 may include a cartoon or animated character, an image of an animal, a solid color, a striped line or other pattern, or any other design to easily distinguish it from other components. Disposed within or on upper sleeve 200 and adjacent the second end 204 is a first sensor component 220. In one example, the first sensor component 220 is a magnet. First sensor component 220 may be attached inside the upper sleeve or on the outside of the upper sleeve. Additionally, upper sleeve may include a plurality of layers, and first sensor component 220 may be embedded within the sleeve between the plurality of layers so that it is not exposed to the environment.

Assist device 100 may also include a lower sleeve 250 configured to fit at least partially around the buckle and/or a portion of webbing connected to the buckle. Lower sleeve 250 may extend between a first end 252 and a second end 254 and may include a body 255 formed of material similar to that of body 205. In some examples, body 255 may be formed as a generally flat rectangular sheet that is rolled to form a generally round sleeve defining a lumen 280, the lumen being large enough to receive a portion of a webbing and/or a portion of the buckle (FIGS. 2 and 3). A seam 256 or VELCRO® type of fastener may couple two ends of the rectangular sheet together to form the round configuration. Body 255 may have a second distinctive marker 257 that is the same or complementary to the first distinctive marker 207. For example, first distinctive marker 207 and second distinctive marker may include the same cartoon character so that a child is quickly able to ascertain which buckles is associated with a seat belt tongue. Disposed within or on lower sleeve 250 and adjacent the first end 252 is a second sensor component 270 having, for example, a reed switch. Second sensor component 270 may be attached inside the lower sleeve or on the outside of the lower sleeve. Additionally, lower sleeve may include a plurality of layers, and second sensor component 270 may be embedded within the sleeve between the plurality of layers so that it is not exposed to the environment. In at least some examples, the two sensor components are considered in a closed condition when they are within 1 inch of each other, and in an open condition when they are more than 1 inch apart. In at least some examples, lower sleeve may be formed of a more rigid material than upper sleeve so that the buckle can more easily protrude from the seat and be quickly found by the user.

A schematic of a reed switch is shown in FIGS. 5A-B. In a simple reed switch, a pair of ferromagnetic flexible metal contacts 502,504 are disposed within a hermetically sealed envelope 510, the contacts being in the open position (FIG. 5A) when no external magnetic field is present. When a magnet “M” is brought close to the envelope 510, the contacts 502,504 transition to a closed condition due to the applied magnetic field. An alarm may be triggered when the circuit is open, signaling that the magnet “M” is far from the reed switch. In this way, the system may be used as part of a proximity sensor when a magnet is disposed on a first element, and the reed switch is disposed on a second element, the proximity of the first and second elements being detectable through the use of the magnetic field.

It will be understood that first sensor component 220 and second sensor component 270 may be interchangeable. That is, when used in the form of a proximity sensor having a magnet and a reed switch, the magnet may be disposed on or within either the upper sleeve or the lower sleeve, and the reed switch may be disposed on the opposing sleeve. Moreover, it will be understood that though the present disclosure has been described with reference to a proximity sensor, other types of sensors may be used. These may include capacitive, doppler effect sensors, eddy-current, inductive sensors, optical sensors, radar, sonar or other suitable sensors. In at least some examples, the first and second components may include magnetic components of opposite polarity. The magnetic components may include a first magnet of a first polarity disposed on the upper sleeve, and a second magnet of a second polarity disposed on the lower sleeve, the first polarity and second polarity being opposites. Attraction of the magnets and contact between the two may signal that the belt is properly buckled and may trigger an audio message or a sound.

In some examples, the device 100 may include Bluetooth connectivity so that the status of the device (e.g., whether the two sensor components are close enough to one another to indicate that the seat belt is buckled) may be shared with other devices including an automobile multimedia system, or a cellphone. The Bluetooth components may be disposed in the upper sleeve, the lower sleeve or both. In some examples, the upper and/or lower sleeve may include a speaker configured to play a sound, a chime, music, or audio from a show or movie. For example, the speaker may be configured to play a sound that streams from a telephone or automobile multimedia system. In at least some examples, the upper and/or lower sleeve may also include a headphone jack so that a portable entertainment device (e.g., cellphone, iPad, tablet or laptop) may play music or sounds over the speakers of the sleeves.

In use, an upper sleeve 200 may be disposed around a portion of a webbing adjacent a tongue of a seat belt, the upper sleeve 200 having a first sensor component disposed at an end closer to the tongue, and a lower sleeve 250 may be disposed around a portion of a webbing and/or a buckle of a seat belt, the lower sleeve having a second sensor 270 component disposed at an end closer to the tongue. Upper and lower sleeves 200,250 may be wrapped around the respective components and VELCRO® fasteners may be used to keep them in position. Alternatively, the sleeves may be stitched or include a seam to keep them in a round configuration, and may be slipped over the tongue and buckle, respectively. The markings on the sleeves may be visible to the passenger so that they can quickly ascertain which buckle is to mate with a given tongue. In at least some examples, multiple sets of assistance devices are used (e.g., three sets) in a row of seat, each set of assist device (e.g., each pair of upper sleeve and lower sleeve) having a different marking or pattern and/or color from other sets so that complementary components are quickly identified.

With the first and second electronic components being disposed adjacent one another on respective elements adjacent the tongue and the buckle, an audible alarm may be heard when the two components are disconnected. In at least some examples, the two components will be deemed disconnected when they are approximately ¼ inch or more away from one another. In at least some examples, the two components will be deemed disconnected when they are approximately ½ inch or 1 inch or more away from one another. In this way, a parent may be assured that a child has properly fastened their seat belt. If a seat belt is not fastened, the two components will be separated, and an alarm may sound. Additionally, a primary chirp may be heard when the two sleeve components are initially brought together to announce to the driver and other passengers that a seat belt was properly clicked into position. Such audible messages may be useful to alert the driver of the status of the seat belts in the back row, so that a driver does not have to visually inspect the seat belts when traveling, for example, with children.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A seat belt assist device for use with a seat belt having a webbing, a tongue and a buckle, the assist device comprising:
an upper sleeve for wrapping around a portion of the webbing adjacent the tongue;
a lower sleeve coupled to a portion of the webbing adjacent the buckle;
a first sensor component disposed on the upper sleeve adjacent the tongue; and
a second sensor component disposed on the lower sleeve adjacent the buckle, the first sensor and the second sensor being capable of signaling their position relative to one another.

2. The seat belt assist device of claim 1, wherein the upper sleeve has a first distinctive marker.

3. The seat belt assist device of claim 2, wherein the lower sleeve has a second distinctive marker, the second distinctive marker being the same as the first distinctive marker.

4. The seat belt assist device of claim 2, wherein the lower sleeve has a second distinctive marker, the second distinctive marker being similar to the first distinctive marker.

5. The seat belt assist device of claim 2, wherein the first distinctive marker includes one of a cartoon, an animated character, an image of an animal, a solid color, a striped line and a pattern.

6. The seat belt assist device of claim 1, wherein the upper sleeve wraps around at least a portion of the webbing.

7. The seat belt assist device of claim 1, wherein the upper sleeve fully wraps around the webbing.

8. The seat belt assist device of claim 1, wherein the first sensor includes a magnet, and the second sensor includes a reed switch.

9. The seat belt assist device of claim 1, wherein the first sensor includes a reed switch, and the second sensor includes a magnet.

10. The seat belt assist device of claim 1, wherein a one of the first sensor and the second sensor includes a magnet, and another of the first sensor and the second sensor includes a reed switch.

11. The seat belt assist device of claim 10, further comprising an alarm configured to be triggered when the circuit is open when the magnet is a predetermined distance away from the reed switch.

12. The seat belt assist device of claim 11, wherein the predetermined distance is less than one inch.

13. The seat belt assist device of claim 11, wherein the predetermined distance is less than one inch.

14. The seat belt assist device of claim 1, further comprising a wireless module for connecting to at least one of an automobile multimedia system or a cellphone.

15. The seat belt assist device of claim 1, further comprising a speaker coupled to at least one of the upper sleeve and the lower sleeve, the speaker being configured to play a sound to signal proximity of the upper sleeve and the lower sleeve.

16. The seat belt assist device of claim 1, wherein the speaker is configured to play a sound to signal mating of the buckle and the tongue.

17. The seat belt assist device of claim 15, wherein the lower sleeve and the upper sleeve signal that they are disconnected when the first sensor and the second sensor are approximately ¼ inch or more away from one another.

18. The seat belt assist device of claim 15, wherein the lower sleeve and the upper sleeve signal that they are disconnected when the first sensor and the second sensor are approximately 1 inch or more away from one another.
